(19) United States
(12) Patent Application Publication
(10) Pub. No.: US 2007/0150955 A1
(43) Pub. Date: Jun. 28, 2007

(54) Event detection system, management terminal and program, and event detection method

(75) Inventors: Tutomu Murase, Tokyo (JP); Hideyuki Shimonishi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/642,830

(22) Filed: Dec. 21, 2006

(30) Foreign Application Priority Data
Dec. 27, 2005 (JP) 2005-373985

(51) Int. Cl. G06F 12/14

(52) U.S. Cl. 726/23

(57) ABSTRACT

An analyzing terminal 3 monitors a to-be-monitored characteristic amount. When a change in the characteristic amount is detected, the analyzing terminal 3 notifies the effect that a change in the characteristic amount has been detected to a management terminal 4. The management terminal 4 sums up the number of the analyzing terminal having notified a change in the characteristic amount. And, the management terminal 4 determines whether an event has occurred according to the summed-up value.

### BACKGROUND OF THE INVENTION

The present invention relates to an event detection system, and more particularly to a system for detecting events such as a virus, a worm, an unauthorized access, a DoS attack or a DDoS attack that are occurring in an entirety of a network.

Recently, with a development in an information process network, an attack to a computer etc. connected to the network has become a big social problem. As the kind of the attacks, there exist an action of infecting the computer with an unauthorized program that is called a virus, thereby to do an unauthorized act by employing this infected computer, the DoS (Denial of Service) attack of transmitting packets to a predetermined server all at once, the DDoS (Distributed-Denial of Service) attack of transmitting packets to the computer, being an object of attack, from a plurality of the computers all at once, or the like.

Above all, the DDoS attack, in which software that is called an agent is installed into a third-party computer from an intruder's computer via a communication network, is an attack of transmitting a large amount of the packets to the computer, being an object of attack, in a short time by remotely controlling this agent. As a result, a system resource is consumed up in the computer, being an object of attack, which leads to a failure to performing a communication process of a TCP (Transmission Control Protocol) and a service process over the TCP, and gives rise to a system down.

For the purpose of protecting the computer from such a DDoS attack, the technique has been studied of incorporating a DDoS trace back function and various IDSs (Intrusion Detection System) into a router. In the conventional IDS, for example, the router acquires a packet over a flow-in route, and extracts a destination address and a transmission source address described in a header of the above packet. And, transmission of a large amount of the packets from one transmission source to one destination in a short time is recognized to be an unauthorized access.

However, it is pointed out that the IDS, which is incorporated into the router, fails to detect the packets under a current situation where traffics as large as a giga order concentrate in one circuit line, and does not function well. Additionally, so as to enhance a processing speed of the IDS, an introduction of a fast server, and an improvement in firmware and software has been promoted; however any of them cannot solve the problem of a failure to detect the packet completely. Further, it is also difficult to install the trace back function into a large number of the routers in a short time period, whereby it is difficult to realize a monitor system employing the trace back function in a near future.

Under such a root of the problem, the technology has been proposed of mounting the monitoring systems on the route to the computer, being a target, and determining that the unauthorized access has occurred, i.e. the computer is under the DDoS attack in the case that the number of an access to each monitoring system has exceeded a predetermined threshold.

However, in the attack of setting up an attack program to a large number of the distributed computers for a purpose of producing a step, thereby to simultaneously transmit a large amount of the packets to the computer, being a target, from a large number of computers each of which is employed as a step like the case of the DDoS attack, the unauthorized access reaches the computer, being a target, via a plurality of the routes. For this, only mounting the monitoring system into each route caused the unauthorized access to be easily overlooked because the access number did not exceed the threshold employed for determining the unauthorized access.

Thereupon, the technology has been proposed that a management terminal sums up a result collected in each route to detect the unauthorized access based upon the summed-up result (for example, JP-P2004-164107A, which is hereinafter referred to be Patent document 1). Hereinafter, a summary of this technology will be explained by employing FIG. 1.

Upon making a reference to FIG. 1, analyzing terminals 100₁ to 100₅ that monitor the unauthorized access on the route are arranged. Each of the analyzing terminals 100₁ to 100₅ detects an access suspicious as the unauthorized access, and transmits its detection number to a management terminal 200. The management terminal 200 sums up the number of the access suspicious as the unauthorized access from each of the analyzing terminals 100₁ to 100₅ and determines that the unauthorized access is occurring when this summed-up value exceeds a preset threshold. For example, when it is assumed that the threshold set in the management terminal 200 is 100, the analyzing terminals 100₂ and 100₅ detect the access suspicious as the unauthorized access, and its detection number is 60 and 50, respectively, the analyzing terminals 100₂ and 100₅ notify 60 and 50, being the number of the access suspicious as the unauthorized access, to the management terminal 200. Additionally, the other analyzing terminals 100₁, 100₃ and 100₄ have not detected the access suspicious as the unauthorized access, whereby they do not notify the number of the suspicious access to the management terminal 200. The management terminal 200 sums up 60 and 50, being the notified number of the access suspicious as the unauthorized access, respectively, and calculates 110, being a total number. The total number is 110, which has exceeded the threshold 100, whereby the management terminal 200 determines that the unauthorized access is occurring.

However, the technology of the patent document 1 is only a technology of obtaining the total value of the number of the access suspicious as the unauthorized access detected by each analyzing terminal to determine the unauthorized access by comparing this total value to the threshold. Particularly, each analyzing terminal detected the access suspicious as the unauthorized access independently, whereby there existed the case that a determination was erroneously made because the management terminal made a determination based upon the total value of the number of the access suspicious as the unauthorized access that was notified by each analyzing terminal even though the access suspicious as the unauthorized access was detected by each analyzing terminal based upon the due reason. For example, in an example of FIG. 1, even though the reason why the analyzing terminals 100₂ detected the access suspicious as the unauthorized access, and the reason why the analyzing terminals 100₅ detected the access suspicious as the unauthorized access differ from each other, the total value of 60 and 50, being its detection number, respectively, becomes 110, which exceeds the threshold of the management terminal, whereby the management terminal determines erroneously that the unauthorized access has occurred.

Further, in the technology of the patent document 1, the unauthorized access is determined based upon the total value of the number of the access suspicious as the unauthorized access detected by each analyzing terminal, whereby the determination is affected by the number of the access suspicious as the unauthorized access that is detected by each analyzing terminal. For example, in a case where one analyzing terminal has detected the access suspicious as the unauthorized access so that the number thereof exceeds the threshold set in the management terminal due to an increase by chance in an access to a specific server, the management terminal determines erroneously that the unauthorized access has occurred in the entirety of the network although the access suspicious as the unauthorized access is not detected particularly in the other analyzing terminal.

In addition hereto, the technology of the patent document 1 is not capable of detecting an event like the unauthorized access that is occurring in the entirety of the network. This is, for example, the case that the access suspicious as the unauthorized access is occurring in each analyzing terminal even though the number of the access suspicious as the unauthorized access detected in each analyzing terminal is not so numerous. Detecting this necessitates setting the threshold of the management terminal side at a low level, which suppresses an increase in the total value of the number of the access suspicious as the unauthorized access to some extent. However, setting the threshold at an extremely low level allows a determination to be made excessively also in the case that the access number has increased by chance largely as compared with the normal situation, or the like, which causes an erroneous determination to be augmented.

### SUMMARY OF THE INVENTION

The present invention has been accomplished in consideration the above-mentioned problems, and an object thereof is to provide the technology capable of detecting the event that is occurring in the entirety of the network.

Further, an object of the present invention is to provide the technology capable of determining whether or not the event that is occurred in a device such as a server arranged over the network is occurring in the entirety of the network.

Yet further, an object of the present invention is to provide the technology capable of detecting the event that is occurring in the network, or at multi points over the network.

The first invention for solving the above-mentioned problems, which is an event detection system, is characterized in including a detection point for detecting a change in a to-be-monitored characteristic amount, and event detector for, based upon a number of a detection point at which a change in the to-be-monitored characteristic amount has been detected, detecting an event.

The second invention for solving the above-mentioned problems is characterized in that, in the above-mentioned first invention, the event detector, which has a predetermined threshold set, is configured to determine that the event has occurred in a case where the number of the detection point at which a change in the characteristic amount has been detected has exceeded the threshold.

The third invention for solving the above-mentioned problems is characterized in that, in the above-mentioned first invention, the event detector, which has a predetermined threshold set, is configured to determine that the event has occurred in a case where a ratio of the number of the detection point at which a change in the characteristic amount has been detected over the number of all detection points has exceeded the threshold.

The fourth invention for solving the above-mentioned problems is characterized in that, in one of the above-mentioned first invention to the third invention, the event detector includes a weighter for making a weighting for the detection point at which a change in the characteristic amount has been detected, and event detector for, based upon the number of the point for which a weighting has been made, detecting the event.

The fifth invention for solving the above-mentioned problems is characterized in, in the above-mentioned fourth invention, deciding the weighting responding to an appliance that the detection point monitors.

The sixth invention for solving the above-mentioned problems is characterized in, in the above-mentioned fourth invention, deciding the weighting responding to a reliability degree of the detection point.

The seventh invention for solving the above-mentioned problems, which is a management terminal, is characterized in including event detector for, based upon a number of a detection point at which a change in a to-be-monitored characteristic amount has been detected, detecting an event.

The eighth invention for solving the above-mentioned problems is characterized in that, in the above-mentioned seventh invention, the event detector, which has a predetermined threshold set, is configured to determine that the event has occurred in a case where the number of the detection point at which a change in the characteristic amount has been detected has exceeded the threshold.

The ninth invention for solving the above-mentioned problems is characterized in that, in the above-mentioned seventh invention, the event detector, which has a predetermined threshold set, is configured to determine that the event has occurred in a case where a ratio of the number of the detection point at which a change in the characteristic amount has been detected over the number of all detection points has exceeded the threshold.

The tenth invention for solving the above-mentioned problems is characterized in that, in one of the above-mentioned seventh invention to the ninth invention, the event detector includes a weighter for making a weighting for the detection point at which a change in the characteristic amount has been detected, and event detector for, based upon the number of the point for which a weighting has been made, detecting the event.

The eleventh invention for solving the above-mentioned problems is characterized in, in the above-mentioned tenth invention, deciding the weighting responding to a to-be-monitored appliance.

The twelfth invention for solving the above-mentioned problems is characterized in, in the above-mentioned tenth invention, deciding the weighting responding to a reliability degree of the detection point.

The thirteenth invention for solving the above-mentioned problems, which is a program of an information processing unit, is characterized in causing the information processing unit to execute an event detection process of, based upon a number of a detection point at which a change in a to-be-monitored characteristic amount has been detected, detecting an event.

The fourteenth invention for solving the above-mentioned problems is characterized in that, in the above-mentioned thirteenth invention, the event detection process is a process of, in a case where the number of the detection point at which a change in the characteristic amount has been detected has exceeded a predetermined threshold, determining that the event has occurred.

The fifteenth invention for solving the above-mentioned problems is characterized in that, in the above-mentioned thirteenth invention, the event detection process is a process of, in a case where a ratio of the number of the detection point at which a change in the characteristic amount has been detected over the number of all detection points has exceeded a predetermined threshold, determining that the event has occurred.

The sixteenth invention for solving the above-mentioned problems is characterized in that, in one of the above-mentioned thirteenth invention to the fifteenth invention, the event detection process is a process of making a weighting for the detection point at which a change in the characteristic amount has been detected, and detecting the event based upon the point for which a weighting has been made.

The seventeenth invention for solving the above-mentioned problems is characterized in, in the above-mentioned sixteenth invention, deciding the weighting responding to a to-be-monitored appliance. The eighteenth invention for solving the above-mentioned problems is characterized in, in the above-mentioned sixteenth invention, deciding the weighting responding to a reliability degree of the detection point.

The nineteenth invention for solving the above-mentioned problems, which is an event detection method, is characterized in detecting an event based upon a number of a detection point at which a change in a to-be-monitored characteristic amount has been detected.

The twentieth invention for solving the above-mentioned problems is characterized in, in the above-mentioned nineteenth invention, determining that the event has occurred in a case where the number of the detection point at which a change in the characteristic amount has been detected has exceeded a predetermined threshold.

The twenty-first invention for solving the above-mentioned problems is characterized in, in the above-mentioned nineteenth invention, determining that the event has occurred in a case where a ratio of the number of the detection point at which a change in the characteristic amount has been detected over the number of all detection points has exceeded a predetermined threshold.

The twenty-second invention for solving the above-mentioned problems is characterized in, in one of the above-mentioned nineteenth invention to the twenty-first invention, making a weighting for the detection point at which a change in the characteristic amount has been detected, and detecting the event based upon the number of the point for which a weighting has been made.

The twenty-third invention for solving the above-mentioned problems is characterized in, in the above-mentioned twenty-second invention, deciding the weighting responding to an appliance that the detection point monitors.

The twenty-fourth invention for solving the above-mentioned problems is characterized in, in the above-mentioned twenty-second invention, deciding the weighting responding to a reliability degree of the detection point.

The present invention makes it possible to detect the event that has occurred in the network, and the network appliances such as the server and the terminal that the management terminal manages without being affected by a detection result by some analyzing terminals. The reason is that the event that is occurring in the entirety of the network is detected, by paying an attention to information as to how many analyzing terminals having detected the event exist, out of the analyzing terminals arranged in the network etc.

### BRIEF DESCRIPTION OF THE DRAWINGS

This and other objects, features and advantages of the present invention will become more apparent upon a reading of the following detailed description and drawings, in which:

FIG. 1 is a view for explaining the prior art;

FIG. 2 is a view for explaining a summary of an embodiment of the present invention;

FIG. 3 is an operational flowchart of a summary of the embodiment of the present invention;

FIG. 4 is a view for explaining an example of a summary in this embodiment;

FIG. 5 is a block diagram of the analyzing terminal 3 in an example 1;

FIG. 6 is a block diagram of the management terminal 4 in the example 1;

FIG. 7 is a block diagram of the management terminal 4 in the example 2;

FIG. 8 shows an example of a weighting value that is added to a notification from the analyzing terminal; and

FIG. 9 shows an example of a weighting value that is added to a notification from the analyzing terminal.

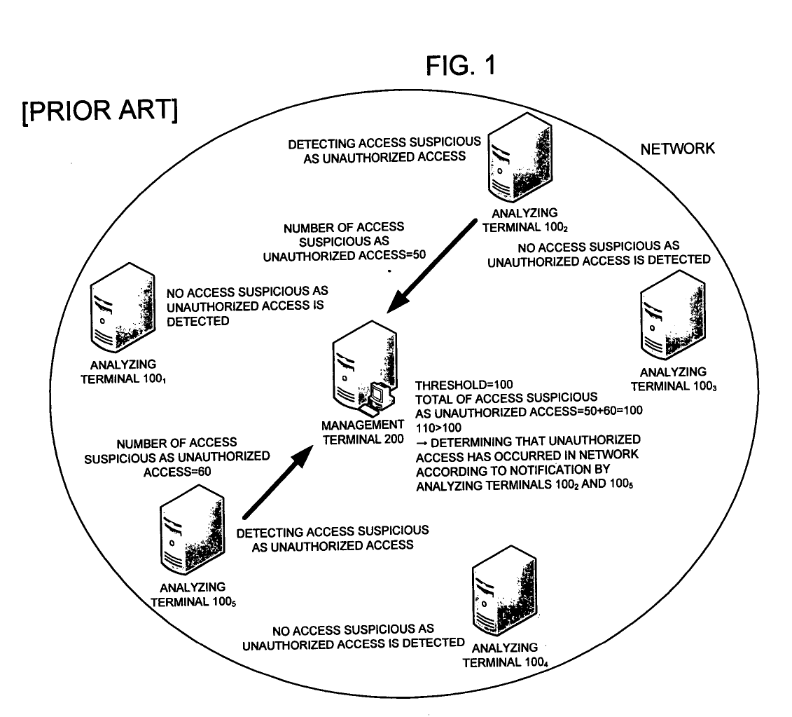

### DESCRIPTION OF THE EMBODIMENTS

The embodiment of the present invention will be explained.

The great characteristic of the present invention lies in paying an attention to information as to how many analyzing terminals having detected the event such as an access suspicious as the unauthorized access exist, out of the analyzing terminals arranged in the network etc., thereby to detect the event that is occurring in the entirety of the network. Herein, the so-called event, which is a phenomenon that occurs over the network appliance or the network, is a concept including, for example, not only the virus, the worm, the unauthorized access, the attacks for applying an excessive load to the server such as the DoS attack or the DDoS attack, and a phenomenon of congesting a link in some cases and applying a load to the network appliances such as the terminal and the router in some cases, but also a detection of a popularity investigation, being a favorable phenomenon, or the like, and a phenomenon as a result of having been carried out by a manager responding to a necessity at the time of a test and an inspection.

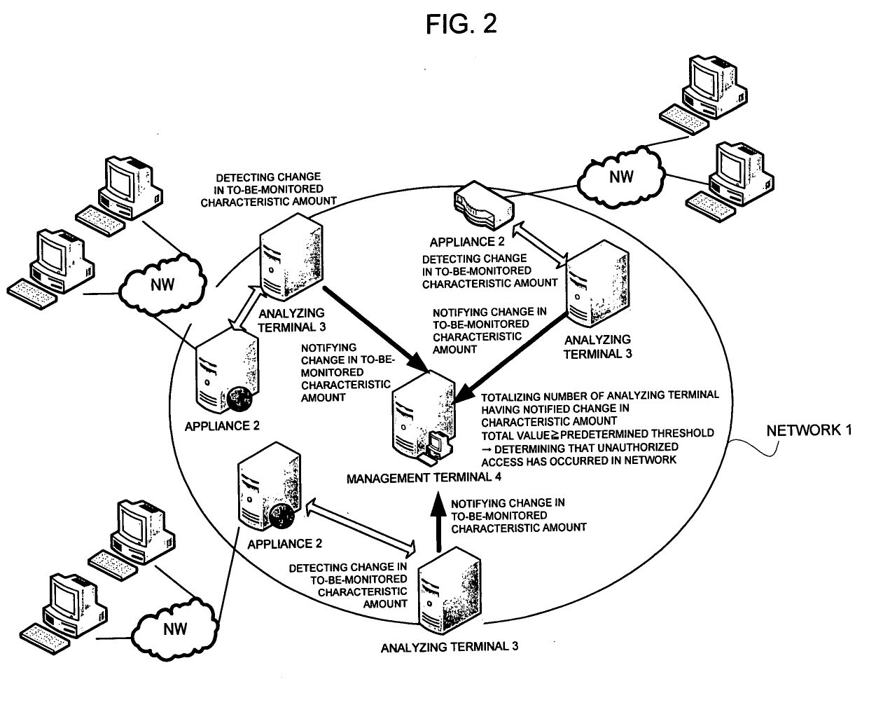

Hereinafter, a summary of the present invention will be explained. FIG. 2 is a view for explaining a summary of the embodiment of the present invention.

Upon making a reference to FIG. 2, the event detection system in the present invention includes network appliances 2 such as a router and a server arranged over a network 1, and an analyzing terminals 3 for detecting a change in the to-be-monitored characteristic amount in this network appliance 2, and a manager terminal 4 for, upon receipt of a notification from this analyzing terminals 3, detecting the event that is occurring in the network or the network appliance 2.

The so-called characteristic amount of the network appliance 2 that the analyzing terminal 3 monitors is one obtained by numerically expressing the to-be-monitored characteristic. The object of monitoring and this characteristic amount differ for each event that should be detected, that is, in a case where the event that should be detected is link congestion, it follows that the object of monitoring is a transmission packet, and the characteristic amount is a data amount of the transmission packet. Further, in a case where the event that should be detected is the DoS attack or the DDos attack, it follows that the object of monitoring is a TCP transmission packet, or a request of a HTTP/FTP, and the characteristic amount is a ratio of a ACK packet and a data packet, the number of a get request or the number of a reload request of the HTTP/FTP. Further, in a case where the event that should be detected is a virus/warm invasion, it follows that the object of monitoring is a received mail, and the characteristic amount is the number of the attached file.

Further, the so-called change in the characteristic amount that the analyzing terminal 3 detects, which signifies that a state where the characteristic amount differs from that in the normal state, a strange state, or a very rare state is reached, is, for example, an increase in the data amount of the transmission packet, an increase in the number of the attached file, an increase in the access number, a change in the destination (for example, in a case of causing the virus worm to diffuse, communication with the communication destination is made more frequently than usually, whereby there exists a change in the address number of the communication destination, or in a case of being under an attack by a port scan, or of transmitting the port scan, different ports, each of which has an identical destination, are accessed, whereby there exists a change in the number of the port that is accessed for an identical destination), a change in the order in which an access is made, a change in the order of a command that is key-typed, a change in the order of a process ranging from setting up a PC up to starting it, a change in the kind of application that is activated at the time of starting the attached file of the mail, a change in a time zone during which communication is made, a change in a combination of the applications that are activated simultaneously, etc.

Additionally, for a method of detecting a change in the characteristic amount, the technologies etc. described in, for example, JP-P2004-054370A (AUTOREGRESSIVE MODEL LEARNING DEVICE FOR TIME SERIES DATA AND DEVICE FOR DETECTING DEVIATED VALUE AND CHANGING POINT USING THE SAME), the document “V. Guralnik and J. Srivastava. Event Detection from Time Series Data, in Proceedings of the Fifth ACM SIGKDD International Conference on Knowledge Discovery and Data Mining, pp: 33-42, ACM Press, 1999.” or the document “K. Yamanishi, J. Takeuchi, Y. Maruyama: “Three Methods for Statistical Anomaly Detection (in Japanese),” IPSJ Magazine (Joho Shori), Vol. 46, No. 1, pp. 34-40, 2005” can be applied.

The management terminal 4 receives a notification saying a detection of a change in the characteristic amount from the each analyzing terminal 3, and detects the event that is occurring over the network. Specifically, the management terminal 4 detects the event based upon the number of the analyzing terminal having notified a change in the characteristic amount. With a determination of the event detection by the management terminal 4, it is determined that the event has occurred in the case that the total value of the number of the analyzing terminal 3 having notified a change in the characteristic amount has exceeded the threshold, which has been pre-set to the management terminal 4. Additionally, the determination, which is not limited to such a determination, may be made, for example, by weighting the notification from each analyzing terminal responding to an importance degree of an object that the analyzing terminal monitors in some cases, and further, based upon a ratio of the analyzing terminal having made a notification over all analyzing terminals in some cases, instead of the determination based upon the number of the notification.

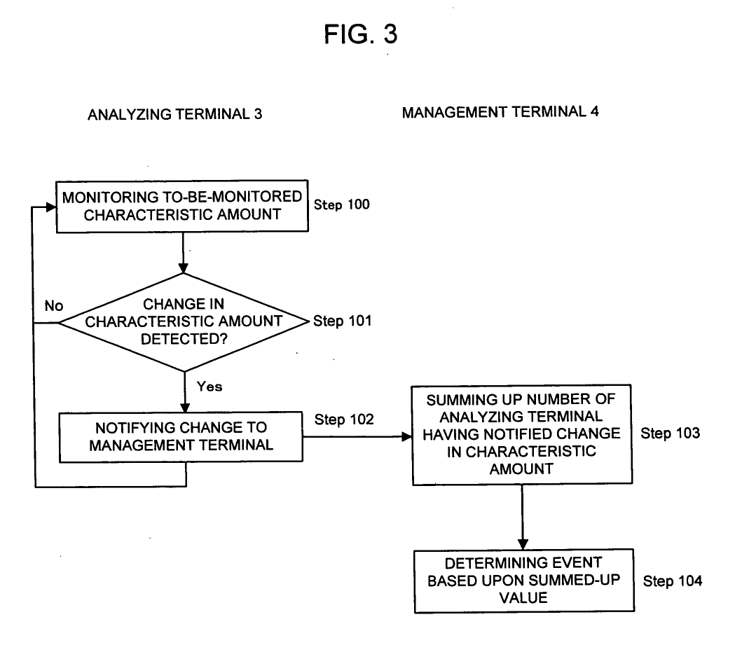

The event detection system configured in such a manner operates as described below. FIG. 3 is an operational flowchart of the event detection system.

At first, the analyzing terminal 3 monitors the to-be-monitored characteristic amount (Step 100). When a change in the characteristic amount is detected (Step 101), the analyzing terminal 3 notifies the effect that a change in the characteristic amount has been detected to the management terminal 4 (Step 102).

On the other hand, the management terminal 4 sums up the number of the analyzing terminal having notified a change in the characteristic amount (Step 103). And, it determines whether the event has occurred based upon the summed-up value (Step 104).

Next, a specific operation of detecting the event will be explained.

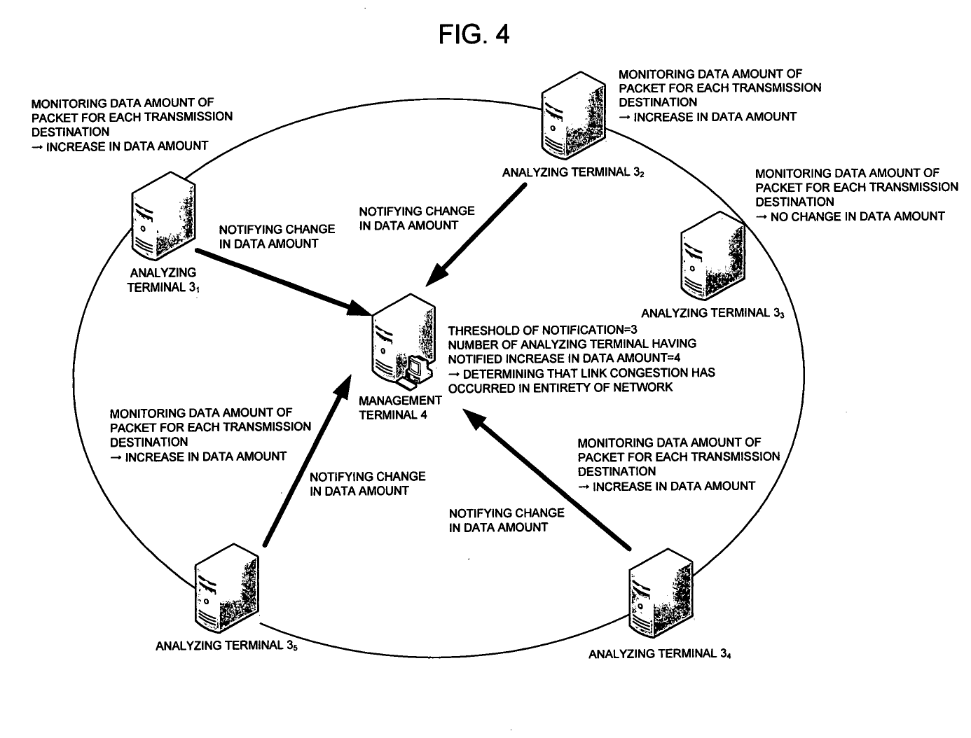

FIG. 4 is a view for explaining a specific operation of a summary in this embodiment. Additionally, in the following explanation, it is assumed that each of the analyzing terminals 3₁ to 3₅ monitors the data amount (the characteristic amount) of the transmission packet that goes through network appliances 2₁ to 2₅, or the transmission packet that is received. Further, the management terminal 4 determines/detects that the link congestion is occurring in the network when the number of the notification from the analyzing terminal exceeds three.

At first, each of the analyzing terminals 3₁ to 3₅ monitors the transmission packet of the network appliances 2₁ to 2₅, being an object of monitoring, and monitors the data amount of the transmission packet, being its characteristic amount. And, in a case where the data amount of the transmission packet is more numerous than the data amount of the packet that is usually transmitted, it detects a change in the data amount, and notifies this to the management terminal 4.

In the system configured as described above, for example, in a case where the data amount has increased in the network appliances 2₁, 2₂, 2₄, and 2₅, the analyzing terminals 3₁, 3₂, 3₄, and 3₅ detect a change in the characteristic amount, respectively, and notify it to the management terminal 4. The management terminal 4 sums up the number of the analyzing terminal having notified an increase in the data amount of the transmission packet (a change in the characteristic amount). Herein, the number of the analyzing terminal having made a notification is four, and the threshold pre-set in the management terminal 4 is three, whereby the total number (=4) of the analyzing terminal having detected a change in the characteristic amount has exceeded this threshold (=3). Thus, the management terminal 4 determines that the link congestion is occurring in the network with which the network appliances 2₁, 2₂, 2₄, and 2₅ have a connection, respectively. That is, the detection is made of the event that is referred to as the link congestion.

As mentioned above, the present invention makes it possible to detect the event that is occurring in the entirety of the network without being affected by the characteristic amount of some analyzing terminals not because of paying an attention to the characteristic amount itself that is notified from the analyzing terminal, but because of determining occurrence of the event based upon the number of the analyzing terminal having detected abnormality.

Hereinafter, specific examples will be explained

### Example 1

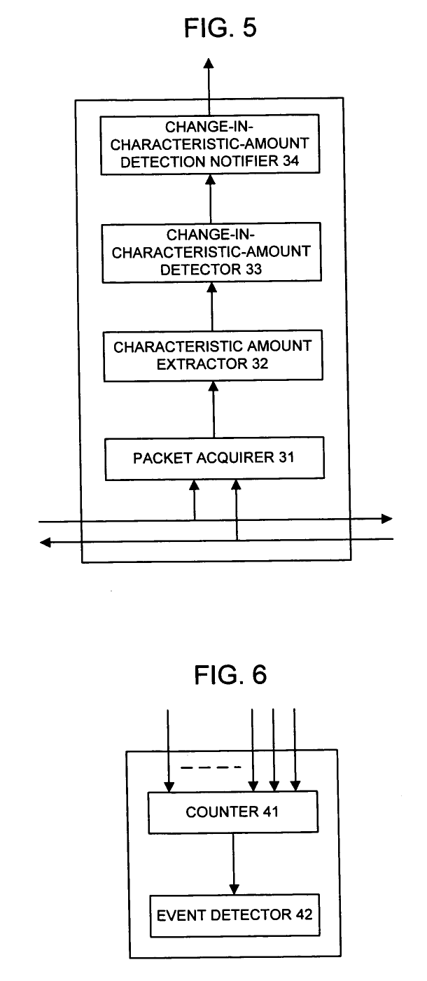

In this example 1, a specific configuration will be described of the analyzing terminal 3 and the management terminal 4 in the case of having applied the present invention for detecting the link congestion of the network. FIG. 5 is a block diagram of the analyzing terminal 3 and FIG. 6 is a block diagram of the management terminal 4.

The analyzing terminal 3 includes a packet acquirer 31 for acquiring the packet over the network appliance or the route that the analyzing terminal 3 monitors, a characteristic amount extractor 32 for extracting the to-be-monitored characteristic amount from the acquired packet, a change-in-a-characteristic-amount detector 33 for detecting a change in the characteristic amount, and a change-in-a-characteristic-amount detection notifier 34.

The packet acquirer 31 acquires the transmission packet over the route, and outputs it to the characteristic amount extractor 32.

The characteristic amount extractor 32 is for extracting the characteristic amount of the packet, being an object of monitoring. In this example, the event that is detected is the link congestion, whereby the characteristic amount that is extracted is the transmission data amount for each transmission destination IP address of the transmission packet. And, the characteristic amount extractor 32 outputs the transmission data amount extracted for each transmission destination IP address to the change-in-a-characteristic-amount detector 33.

The change-in-a-characteristic-amount detector 33 successively collects statistic of the transmission data amount for each transmission destination IP address, and detects a change in the transmission data amount by employing an existing changing point detection system. And, in a case of having detected the change, the change-in-a-characteristic-amount detector 33 notifies it to the change-in-a-characteristic-amount detection notifier 34.

Specifically, the change-in-a-characteristic-amount detector 33 compares the number of the packet that is transmitted every one second with the threshold, and in a case where it is larger than the threshold, detects that a change in the transmission data amount has occurred. Herein, it is assumed that the value obtained by computing the mean number of the packets, which are transmitted every one second, retroactively to the time point that is 60 seconds behind the observation point to double this mean value is a threshold. That is, this mean value is the value in a normal state, and if the observed value exceeds the threshold obtained by doubling this mean value (the data amount in a normal state), the change-in-a-characteristic-amount detector 33 determines that the above observed-value is an abnormal value.

Additionally, in addition to the example of counting all packets, it is also possible to detect a change in the transmission data amount by counting the threshold and the observed value for either of a combination set of four kinds of information of a transmission source IP address, a transmission destination IP address, a protocol number, and a transmission source session port number (or a transmission side TCP/UDP port number), or a combination set of four kinds of information of the former three kinds of information and a transmission destination session port number (or a reception side TCP/UDP port number).

Upon receipt a change in the data amount from the change-in-a-characteristic-amount detector 33, the change-in-a-characteristic-amount detection notifier 34 notifies this result. For the above notification is employed information of the packet that is transmitted for one second during which a change has been detected. Specifically, it includes five kinds of information of each packet, and information of the leading 40 bytes of the packet. The five kinds of information are the transmission source IP address, the transmission destination IP address, the protocol number, and the transmission source session port number (or the transmission side TCP/UDP port number), and the transmission destination session port number (or the reception side TCP/UDP port number). Additionally, unless the transmission source and the destination are confined to specific ones, these kinds of the information are unnecessary; however, exclusion of the specific IP address, or the like requires them. For example, packaging the analysis function of the present invention into the terminal necessitates detecting the changing point in communication with the outside in order to detect the virus. Thereupon, the case that the terminal makes communication locally (for example, the case of accessing a LAN disc (a hard disc having a connection via Either) of a private network) has to be differentiated from the case that the terminal makes communication with the outside, which requires these kinds of information.

Further, in the information of the leading 40 bytes is included information such as a sequence number in the TCP head. In a case of detecting the virus etc., so as to differentiate normal communication that the virus originates from abnormal communication that is originated due to an abnormal operation of the terminal or the soft, a reference is made to information such as a sequence number. Differentiation of the abnormal communication that is originated due to an abnormal operation of the terminal or the soft allows only the normal communication that the virus originates to be detected as a changing point, that is, an effect of removing noise to be obtained, which can enhance a detection precision. The reason is that normally, the sequence number is continuous, but in sending out the TCP packet due to the abnormal operation, the entirely nonsense sequence number might be used.

The management terminal 4 includes a counter 41 for counting the notification from the analyzing terminal 3, and an event detector 42 for, upon receipt of a result by the counter 41, detecting the event.

The counter 41 is for counting the notification from each analyzing terminal 3 one by one to output its total value to the event detector 42.

The event detector 42, which has a predetermined threshold set, detects that the link congestion (event) has occurred when the total value from the counter 41 exceeds the threshold.

### Example 2

The example 2 of the present invention will be explained.

In the foregoing example 1, the management terminal 4 detected whether the event occurred depending upon whether or not the total value of the number of the notification from each analyzing terminal 3 exceeded the set threshold. The example 2 is characterized in that the management terminal 4 determines a detection of the event according to a ratio of the number of the analyzing terminal having made a notification over the number of the entire analyzing terminals.

For this, the event detector 42 of the management terminal 4, which has the total number of the entire analyzing terminals 3 to be managed by the event detector 42 stored, computes a ratio of the total value of the number of the analyzing terminal that is notified from the counter 41 over the total number of the entire analyzing terminals 3. And, the management terminal 4 is configured so as to detect occurrence of the event in a case where this ratio has exceeded a pre-set threshold. For example, the management terminal 4 determines that the event has occurred in a case where the number of the analyzing terminal having notified the effect that the characteristic amount has changed has exceeded 60 under the condition that the total number of the entire analyzing terminals is 100, and occurrence of the event is determined when a ratio has exceeded 60%.

### Example 3

The example 3 of the present invention will be explained.

In the foregoing example 1 and example 2, the management terminal 4 determined the event by all treating the notification from each analyzing terminal without any differentiation. However, there is the case that depending upon the to-be-monitored network appliance, an importance degree of its analyzing terminal differs. For example, in the analyzing terminal that monitors the appliance handling a large quantity of data such as a backbone server, a change in the to-be-monitored characteristic amount has a large influence upon the entirety. Thereupon, in the example 3, an example of making a weighting analyzing terminal by analyzing terminal to reflect it into a detection of the event will be explained.

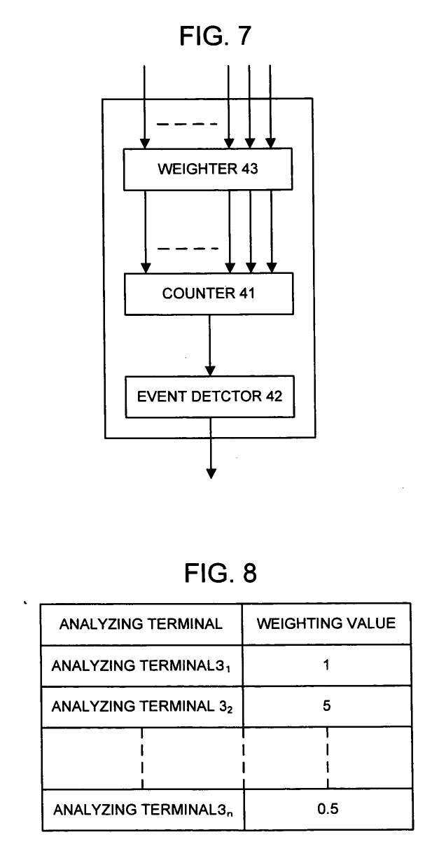

FIG. 7 is a block diagram of the management terminal 4 in the example 3.

The management terminal 4 of the example 3 includes a weighter 43 in addition to the component of the example 1. As shown in FIG. 8, this weighter 43 has a weighting value, which is added to the notification from the analyzing terminal, set. For example, In FIG. 8, the weighter 43 is configured so as to weight the notification from the analyzing terminal 3₂, which monitors the backbone server, by a factor of five, and on the other hand, to weight the notification from the analyzing terminal 3ₙ, which monitors the device having less influence, by a factor of 0.5.

In such a manner, the weighter 43 allows the weighted value to be input into the counter 41, the value to be counted, and its total value to be output to the event detector 42.

In the event detector 42, it becomes possible to detect occurrence of the event while the importance degree of the device that the analyzing terminal monitors is reflected.

### Example 4

The example 4 of the present invention will be explained.

In the foregoing example 3, by differentiating the notification of the analyzing terminal monitoring the appliance handling a large quantity of data such as the backbone server from that of the analyzing terminal other than it, the notification was weighted analyzing terminal by analyzing terminal to reflected this into a detection of the event. However, there is the case that a changing point detection reliability degree for the data appliance that is monitored differs appliance by appliance even though the number of the data appliance that is monitored is identical, so an example of making a weighting responding to the changing point detection reliability degree will be explained.

Herein, the so-called changing point detection reliability degree is a value having an overlooking or an erroneous notification taken into consideration that the changing point detection function has. For example, there is the case that in the observation of the packet number described in the example 1, the packet number is counted erroneously due to the overlooking or the duplicated counting. This is the value that is decided responding to a processing ability of the appliance. For this, the changing point detection reliability degree is assigned responding to a processing ability of the appliance or the like. For example, when it is assumed that the changing point detection reliability degree of the analyzing terminal that monitors a private appliance in a general household is one (1), it is assumed that the changing point detection reliability degree of the analyzing terminal that monitors an appliance for an enterpriser in a corporation enterpriser is five. Further, the example is also possible in which in this example, when the changing point detection reliability degree of the analyzing terminal monitoring the appliances each having a virus countermeasure taken is assumed to be one (1), that of the analyzing terminal other than it is assumed to be 10.

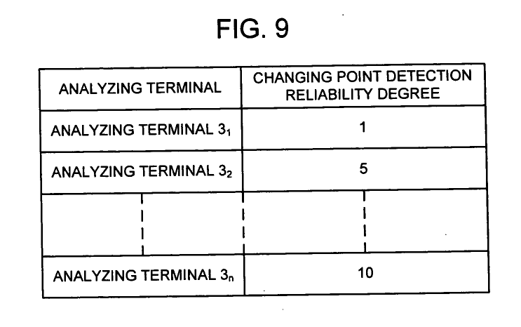

The specific configuration of the example 4 is similar to that of the example 3 in terms of the basic configuration, in which the weighter 43 weights the notification from the analyzing terminal based upon the changing point detection reliability degree. The weighter 43, which has a table as shown in FIG. 9, weights the notification from the analyzing terminal based upon this table. For example, FIG. 9 shows the case that the changing point detection reliability degree of the analyzing terminal 3₁, which is the analyzing terminal monitoring the private appliance in a general household, is one (1), and that of the analyzing terminal 3₂, which is the analyzing terminal monitoring the appliance for an enterpriser in a corporation enterpriser is five, and the weighter 43 weights the notification from the analyzing terminal 3₁ by a factor of one (1), and on the other hand, weights the notification from the analyzing terminal 3₂ by a factor of five based upon this table.

What is claimed is:

1. An event detection system comprising:
a detection point for detecting a change in a to-be-monitored characteristic amount; and
event detector for, based upon a number of a detection point at which a change in the to-be-monitored characteristic amount has been detected, detecting an event.

2. The event detection system according to claim 1, wherein said event detector, which has a predetermined threshold set, is configured to determine that the event has occurred in a case where the number of the detection point at which a change in the characteristic amount has been detected has exceeded said threshold.

3. The event detection system according to claim 1, wherein said event detector, which has a predetermined threshold set, is configured to determine that the event has occurred in a case where a ratio of the number of the detection point at which a change in the characteristic amount has been detected over the number of all detection points has exceeded said threshold.

4. The event detection system according to claim 1, wherein said event detector comprises:
a weighter for making a weighting for the detection point at which a change in the characteristic amount has been detected; and
event detector for, based upon the number of the point for which a weighting has been made, detecting the event.

5. The event detection system according to claim 4, wherein said weighting is decided responding to an appliance that said detection point monitors.

6. The event detection system according to claim 4, wherein said weighting is decided responding to a reliability degree of said detection point.

7. A management terminal, comprising event detector for, based upon a number of a detection point at which a change in a to-be-monitored characteristic amount has been detected, detecting an event.

8. The management terminal according to claim 7, wherein said event detector, which has a predetermined threshold set, is configured to determine that the event has occurred in a case where the number of the detection point at which a change in the characteristic amount has been detected has exceeded said threshold.

9. The management terminal according to claim 7, wherein said event detector, which has a predetermined threshold set, is configured to determine that the event has occurred in a case where a ratio of the number of the detection point at which a change in the characteristic amount has been detected over the number of all detection points has exceeded said threshold.

10. The management terminal according to claim 7, wherein said event detector comprises:
a weighter for making a weighting for the detection point at which a change in the characteristic amount has been detected; and
event detector for, based upon the number of the point for which a weighting has been made, detecting the event.

11. The management terminal according to claim 10, wherein said weighting is decided responding to a to-be-monitored appliance.

12. The management terminal according to claim 10, wherein said weighting is decided responding to a reliability degree of said detection point.

13. A program of an information processing unit, said program causing said information processing unit to execute an event detection process of, based upon a number of a detection point at which a change in a to-be-monitored characteristic amount has been detected, detecting an event.

14. The program according to claim 13, wherein said event detection process is a process of, in a case where the number of the detection point at which a change in the characteristic amount has been detected has exceeded a predetermined threshold, determining that the event has occurred.

15. The program according to claim 13, wherein said event detection process is a process of, in a case where a ratio of the number of the detection point at which a change in the characteristic amount has been detected over the number of all detection points has exceeded a predetermined threshold, determining that the event has occurred.

16. The program according to claim 13, wherein said event detection process is a process of making a weighting for the detection point at which a change in the characteristic amount has been detected, and detecting the event based upon the number of the point for which a weighting has been made.

17. The program according to claim 16, wherein said weighting is decided responding to a to-be-monitored appliance.

18. The program according to claim 16, wherein said weighting is decided responding to a reliability degree of said detection point.

19. An event detection method, wherein an event is detected based upon a number of a detection point at which a change in a to-be-monitored characteristic amount has been detected.

20. The event detection method according to claim 19, wherein it is determined that the event has occurred in a case where the number of the detection point at which a change in the characteristic amount has been detected has exceeded a predetermined threshold.

21. The event detection method according to claim 19, wherein it is determined that the event has occurred in a case where a ratio of the number of the detection point at which a change in the characteristic amount has been detected over the number of all detection points has exceeded a predetermined threshold.

22. The event detection method according to claim 19, wherein a weighting is made for the detection point at which a change in the characteristic amount has been detected to detect the event based upon the number of the point for which a weighting has been made.

23. The event detection method according to claim 22, wherein said weighting is decided responding to an appliance that the detection point monitors.

24. The event detection method according to claim 22, wherein said weighting is decided responding to a reliability degree of the detection point.
